(19) United States
(12) Patent Application Publication
(10) Pub. No.: US 2009/0092806 A1
(43) Pub. Date: Apr. 9, 2009

(54) Solar Control Window Film

(76) Inventor: Hans Chan, Tainan Hsien (TW)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 11/866,534

(22) Filed: Oct. 3, 2007

(51) Int. Cl. B32B 27/08

(52) U.S. Cl. 428/212

(57) ABSTRACT

A solar control window film includes: a light-colored substrate having opposite first and second surfaces; a dark-colored light absorbing layer formed on the second surface of the substrate; an image layer printed on the first surface of the substrate; an adhesive layer formed on the image layer at one side of the image layer opposite to the substrate; and a viewing mechanism that includes a plurality of pin holes extending through the light absorbing layer, the substrate, the image layer and the adhesive layer in a normal direction relative to the solar control window film.

### BACKGROUND OF THE INVENTION

1. Field of the Invention

This invention relates to a solar control window film, more particularly to a solar control window film having an image layer sandwiched between a substrate and an adhesive layer.

2. Description of the Related Art

Conventional solar control window films normally include a multilayered structure and an adhesive layer for attaching the multilayered structure to a vehicle window. The multilayered structure normally includes a metal coating layer for reducing transmission of sun light through the vehicle window and into an interior of the vehicle.

The conventional solar control window film is disadvantageous in that the appearance thereof lacks attractiveness. It is also unrealistic to print an image on the solar control window film in order to provide attractiveness, since the vehicle window would be covered by the image to offset visibility. In addition, air tends to be entrapped between the vehicle window and the adhesive layer of the solar control window film when attaching the solar control window film to the vehicle window.

### SUMMARY OF THE INVENTION

Therefore, the object of the present invention is to provide a solar control window film that can overcome the aforesaid drawbacks of the prior art.

According to this invention, there is provided a solar control window film that comprises: a light-colored substrate having opposite first and second surfaces; a dark-colored light absorbing layer formed on the second surface of the substrate; an image layer printed on the first surface of the substrate; an adhesive layer formed on the image layer at one side of the image layer opposite to the substrate; and a viewing mechanism that includes a plurality of pin holes extending through the light absorbing layer, the substrate, the image layer and the adhesive layer in a normal direction relative to the solar control window film.

### BRIEF DESCRIPTION OF THE DRAWING

Other features and advantages of the present invention will become apparent in the following detailed description of the preferred embodiment of this invention, with reference to the accompanying drawing, in which:

FIG. 1 is a fragmentary sectional view of the preferred embodiment of a solar control window film according to this invention.

### DETAILED DESCRIPTION OF THE PREFERRED EMBODIMENT

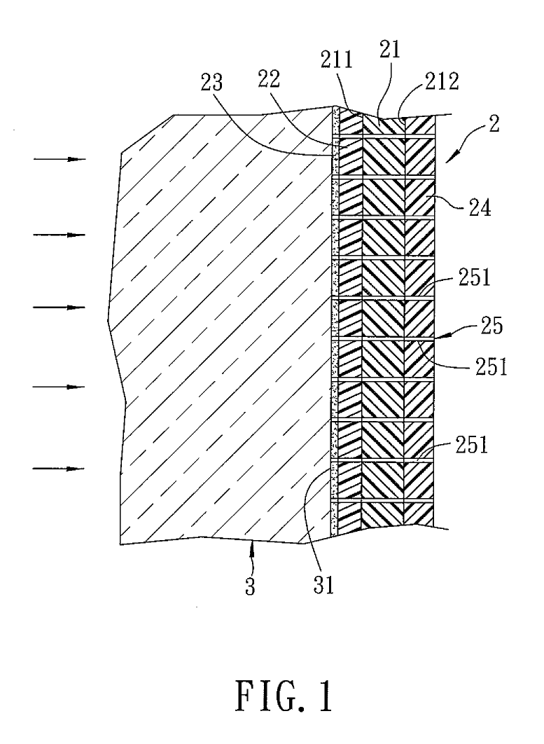

FIG. 1 illustrates the preferred embodiment of a solar control window film 2 according to this invention. The solar control window film 2 can be applied to an interior side 31 of a vehicle window 3, and includes: a light-colored substrate 21 having opposite first and second surfaces 211, 212; a dark-colored light absorbing layer 24 formed on the second surface 212 of the substrate 21; an image layer 22 printed on the first surface 211 of the substrate 21; an adhesive layer 23 formed on the image layer 22 at one side of the image layer 22 opposite to the substrate 21 and adapted to be attached to the interior side 31 of the vehicle window 3; and a viewing mechanism 25 that includes a plurality of pin holes 251 extending through the light absorbing layer 24, the substrate 21, the image layer 22 and the adhesive layer 23 in a normal direction relative to the solar control window film 2 so as to permit unidirectional visibility from an inside of the vehicle through the solar control window film 2.

Preferably, the substrate 21 is made from a material, such as polyvinyl chloride (PVC) or polyethylene terephthalate (PET), and has a metal coating layer (not shown) and an UV inhibitor for reducing transmission of sun light through the vehicle window 3 and into the inside of the vehicle (not shown). The light color of the substrate 21 can enhance the contrast of the image layer 22.

Preferably, the light absorbing layer 24 is made from a dark-colored pigment for absorbing a portion of sun light, further enhancing the contrast of the image layer 22 when viewing from the outside of the vehicle, and permitting visibility from the inside of the vehicle through the pin holes 251.

The solar control window film 2 further includes a releasable liner (not shown) attached to the adhesive layer 23 and releasable from the adhesive layer 23. The releasable liner is removed when the solar control window film 2 is to be attached to the vehicle window 3.

Since the image layer 22 is sandwiched between the adhesive layer 23 and the substrate 21, it can be protected from scratching and exposure to air, moisture, dust, etc.

With the inclusion of the viewing mechanism 25, the person inside the vehicle can view through the solar control window film 2, but cannot see the image layer 22, while the person outside the vehicle can see the image layer 22, but cannot see through the solar control window film 2.

With the inclusion of the image layer 22 in the solar control window film 2 of this invention, the aforesaid drawback of lack of attractiveness associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A solar control window film comprising:
a light-colored substrate having opposite first and second surfaces;
a dark-colored light absorbing layer formed on said second surface of said substrate;
an image layer printed on said first surface of said substrate;
an adhesive layer formed on said image layer at one side of said image layer opposite to said substrate; and
a viewing mechanism that includes a plurality of pin holes extending through said light absorbing layer, said substrate, said image layer and said adhesive layer in a normal direction relative to said solar control window film.

2. The solar control window film of claim 1, wherein said substrate is made from polyvinyl chloride.

3. The solar control window film of claim 1, wherein said substrate is made from polyethylene terephthalate.

4. The solar control window film of claim 1, wherein said light absorbing layer is made from a dark-colored pigment.
